(19) United States
(12) Patent Application Publication
(10) Pub. No.: US 2015/0006350 A1
(43) Pub. Date: Jan. 1, 2015

(54) Electronic Trading Auction with Randomized Acceptance Phase and Order Execution

(71) Applicant: D.E. Shaw & Co., L.P., New York, NY (US)

(72) Inventors: Anoop Prasad, New York, NY (US); Joshua Edward Engelman, Brooklyn, NY (US)

(21) Appl. No.: 13/930,885

(22) Filed: Jun. 28, 2013

(51) Int. Cl. G06Q 40/04

(52) U.S. Cl. CPC G06Q 40/04
USPC 705/37

(57) ABSTRACT

Exemplary embodiments are related to processing electronic trading instructions in an electronic trading exchange environment. Electronic trading instructions can be accepted from auction participants' electronic devices in a first phase of an electronic auction, which can be terminated after expiration of a random time period. The electronic trading instructions accepted during the first phase can be randomly sorted to generate an order queue and the electronic trading instructions can be matched based on a randomized sequence of electronic orders defined by the order queue.

### BACKGROUND

Electronic trading exchanges provide a marketplace for the purchase and sale of financial instruments, such as securities, commodities, futures, exchange traded funds (ETFs), mutual funds, and options. Conventionally, these exchanges allow market participants to submit electronic trading instructions (e.g., placement orders or cancel requests) for execution by a matching engine implemented by the exchange. As a result, most exchanges no longer require human interaction on a “trading floor” to execute a trade transaction. The matching engines implemented by the conventional exchanges can use matching or crossing algorithms to match sell orders with buy orders based on the parameters specified in such orders.

Conventional electronic exchanges can benefit those investors that submit electronic trading instructions earlier in a continuous-auction-based exchange because the electronic trading instructions are typically submitted to the matching engine based on when the orders were received. As a result, the first investor to act may have the first opportunity to be matched with resting orders, and those resting orders may not yet have incorporated the most recent news and market information. In this manner, the trader with the lowest latency (i.e., delay) may have an advantage over those traders with higher latency on the conventional exchange; put another way, a faster trader may have an advantage over a slower trader. Likewise, conventional electronic exchanges can benefit those investors that submit electronic trading instructions later because these investors may have access to more information than the earlier traders, including, for example, knowledge of the parameters of placement orders (e.g., quantity and price) that were already submitted.

The advent of electronic trading exchanges has resulted in some market participants using sophisticated automated trading systems to take advantage of the above order submission strategies. These automated trading systems provide electronic platforms that allow market participants to use algorithms to automatically submit electronic trading instructions with minimal or no human intervention. Such trading systems are commonly used by institutional investors, mutual funds, broker-dealers, and hedge funds.

In some instances, investors use automated trading systems to implement high-frequency trading (HFT) strategies and/or low-latency strategies to programmatically initiate electronic trading instructions. HFT strategies utilized by investors can generate electronic trading instructions based on information received electronically, often times before conventional traders can process the information. HFT strategies typically buy a quantity of a financial instrument and quickly sell the quantity of the financial instrument within minutes or seconds. Investors that use these HFT strategies can perform many of these transactions in one trading period (e.g., a trading day) and the quantities of the financial instruments bought and sold are typically large (e.g., 100,000 or more shares of a stock).

Low-latency trading strategies utilized by investors to submit electronic trading instructions seek to minimize any latencies in submitting electronic trading instructions and typically submit trades within microseconds. Low-latency trading strategies use ultra-low latency networks and/or have co-located trading platforms in the same facilities as the exchange systems to benefit from implementing high-frequency trading strategies to achieve faster execution times compared to other investors having higher latency systems.

The recognized advantages of low-latency platforms has led to a low-latency “arms race” in which many investors are continuously deploying new technology to realize lower latency to maintain or establish an advantage over other investors. Such low-latency platforms can be expensive to develop and maintain. This can lead to substantial costs in hardware and software to maintain an advantage. As a result, investors typically expend resources and money to ensure no one has an advantage over them, but once investors have invested in lower latency systems they may each be no better off than they would have been without the investments; indeed, they may be worse off because of the substantial investment expenditures.

### SUMMARY

The present disclosure relates to an electronic trading exchange with a randomized acceptance time period and order execution features, and methods and computer-readable media relating thereto. Exemplary embodiments advantageously provide a technical solution to reduce incentives that drive market participants to invest in ultra-low-latency infrastructure. While efficient markets have universal benefit, present conditions provide out-sized rewards to market participants that invest in the next microsecond of reduced latency. Exemplary embodiments of the present disclosure seek to curtail the “low-latency arms race” by reducing the impact of low latency trading platforms using a technical solution that limits the usefulness of low latency platforms such that investment in low latency platforms no longer offers a competitive advantage to investors.

In one embodiment, a method of processing electronic trading instructions in an electronic trading exchange environment is provided. The method includes accepting electronic trading instructions from auction participants' electronic devices in a first phase of an electronic auction, programmatically terminating the first phase after expiration of a random time period, executing code to randomly sort the electronic trading instructions to generate an order queue, and programmatically matching the electronic trading instructions based on a randomized sequence of electronic orders defined by the order queue.

In another embodiment, a non-transitory, computer-readable medium storing instruction executable by a processing device in an electronic trading exchange environment is provided. Execution of the instructions by the processing device causes processing of electronic trading instructions in the electronic trading exchange environment including accepting electronic trading instructions from auction participant electronic devices in a first phase of an electronic auction, programmatically terminating the first phase after expiration of a random time period, executing code to randomly sort the electronic trading instructions to generate an order queue, and programmatically matching the electronic trading instructions based on a randomized sequence of electronic orders defined by the order queue.

In yet another embodiment, a system of processing electronic trading instructions in an electronic trading exchange environment is provided. The system includes at least one storage device and a processing device communicatively coupled to at least one storage device. The at least one storage device stores instructions for an order handling process. The processing device is programmed to execute the instructions to accept electronic trading instructions from auction participants' electronic devices in a first phase of an electronic auction, terminate the first phase after expiration of a random time period, randomly sort the electronic trading instructions to generate an order queue, and match the electronic trading instructions based on a randomized sequence of electronic orders defined by the order queue.

In some embodiments, the electronic trading instructions can be randomly sorted by grouping the electronic trading instructions accepted during the first phase to generate groups of electronic trading instructions based on participant identifiers associated with the electronic trading instructions and executing code to randomly sort the groups of electronic trading instructions to generate a random ordering of the groups of electronic trading instructions.

In some embodiments, the random time period is not disclosed to auction participants. In some embodiments, a sequence of auctions can be implemented and a different random time period can be specified for the auctions. Electronic trading instructions that are not matched in an auction can be automatically entered into a subsequent auction or can be automatically canceled.

In some embodiments, a quantity of the electronic trading instructions that can be accepted from each auction participant can be restricted to a specified quantity of electronic trading instructions.

In some embodiments, a quantity of electronic trading instructions submitted by an auction participant can be monitored based on participant identifiers associated with the electronic trading instructions. The quantity of electronic trading instructions submitted by the auction participant can be compared to a specified value. Electronic trading instructions from the auction participant exceeding the specified value can be rejected.

Any combination or permutation of embodiments is envisioned. Other objects and features will become apparent from the following detailed description considered in conjunction with the accompanying drawings. It is to be understood, however, that the drawings are designed as an illustration only and not as a definition of the limits of exemplary embodiments of the present disclosure.

### BRIEF DESCRIPTION OF THE DRAWINGS

FIG. 1 is a block diagram of an exchange engine in accordance with exemplary embodiments of the present disclosure.

FIG. 2 is a block diagram of an electronic trading exchange environment in accordance with exemplary embodiments of the present disclosure.

FIG. 3 is a flowchart of an exemplary embodiment of an order handling process implemented by an embodiment of the exchange engine.

FIG. 4 is a flowchart of an exemplary embodiment of an electronic trading instruction acceptance process implemented by an exemplary embodiment of the exchange engine.

FIG. 5 is a flowchart of an exemplary embodiment of an electronic trading instruction sorting process implemented by an exemplary embodiment of the exchange engine.

FIG. 6 is a block diagram of an exemplary computing device for implementing embodiments of the exchange engine in accordance with exemplary embodiments of the present disclosure.

FIG. 7 is a block diagram of a distributed electronic trading exchange environment in accordance with exemplary embodiments of the present disclosure.

### DESCRIPTION OF EXEMPLARY EMBODIMENTS

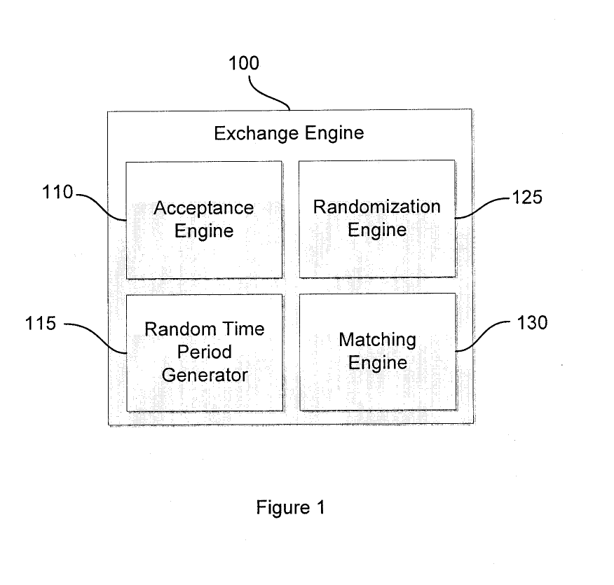

Exemplary embodiments of the present disclosure are related to processing electronic trading instructions (e.g., placement orders and cancel requests) in an auction-based electronic trading exchange environment, as described with respect to FIGS. 1-7. In exemplary embodiments, auction participants' electronic devices can be in communication with one or more computing devices executing an exchange engine, or portions thereof The exchange engine can be programmed to allow auction participants to submit electronic trading instructions for consideration (e.g., execution of placement orders or cancelation of a previously submitted placement orders) in one or more electronic trading auctions implemented by the exchange engine. The exchange engine can be programmed to implement the electronic trading auctions in parallel and/or in sequence.

Exemplary embodiments of the exchange engine can be programmed to receive electronic trading instructions from the auction participants' electronic devices during an acceptance phase of an auction and can terminate the acceptance phase after expiration of a random time period. The auction-based electronic trading exchange environment can be configured such that the auction participants have no knowledge of when the acceptance period will expire. In some embodiments, a distribution and/or range of possible random time periods can be provided to the auction participants. Since the auction participants do not have knowledge of the specific random time period in exemplary embodiments, the auction participants do not know when the acceptance phase is scheduled to terminate. By terminating the acceptance phase upon the expiration of a random time period, exemplary embodiments of the present disclosure can advantageously reduce and/or eliminate attempts by auction participants to gain and/or use more information than other auction participants before submitting electronic trading instructions just prior to the termination of the acceptance phase. The random time period encourages auction participants that wish to participate in a pending auction to submit their electronic trading instructions early in the acceptance phase.

In exemplary embodiments, the electronic trading instructions accepted during the acceptance phase can be grouped based on the auction participants that submitted the electronic trading instructions. By grouping the electronic trading instructions by auction participant, exemplary embodiments of the present disclosure advantageously reduce and/or eliminate an incentive for an auction participant to submit a multitude of orders in a short period of time in an attempt to obtain the best price for a financial instrument. The groups of electronic trading instructions can be randomly sorted to generate an order queue having random ordering (sequence) of the groups of electronic trading instructions. After the groups of electronic trading instructions are randomly sorted, exemplary embodiments of the present disclosure can submit the orders to a matching engine in a sequence defined by the order queue and the matching engine can match orders based on a priority determined, at least in part, by the order queue. By randomly sorting the grouped electronic trading instructions and submitting the groups of electronic trading instructions to the matching engine according to their position in the randomly generated order queue, exemplary embodiments of the present disclosure advantageously reduce and/or eliminate any advantages auction participants would have realized by submitting their electronic trading instructions early in the acceptance phase.

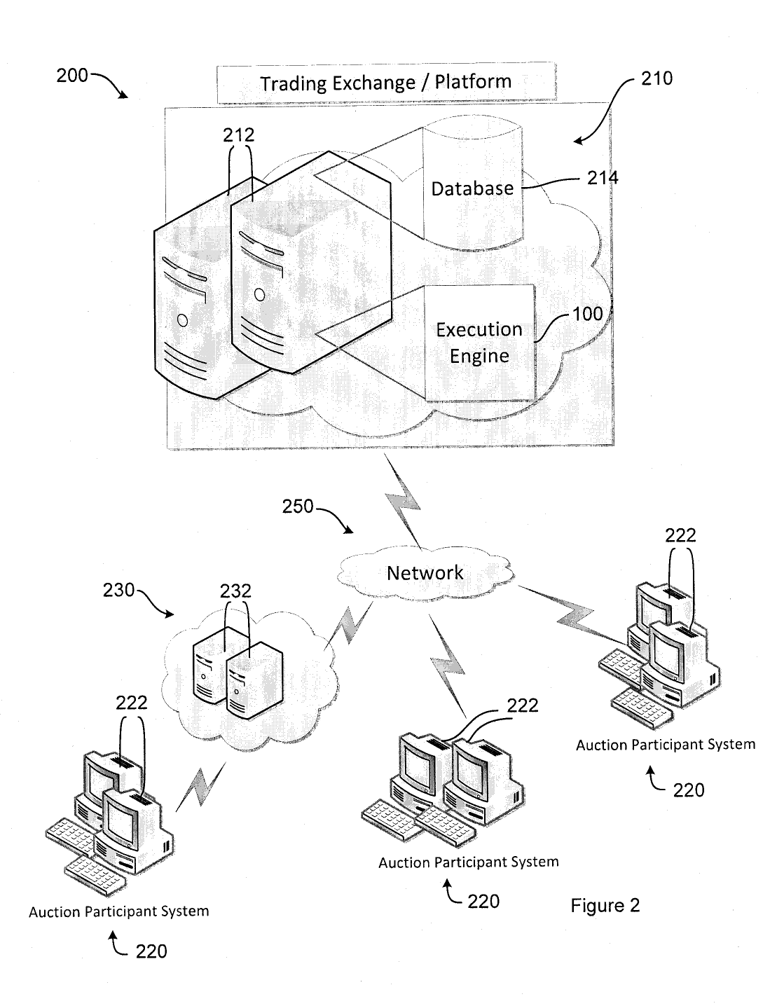

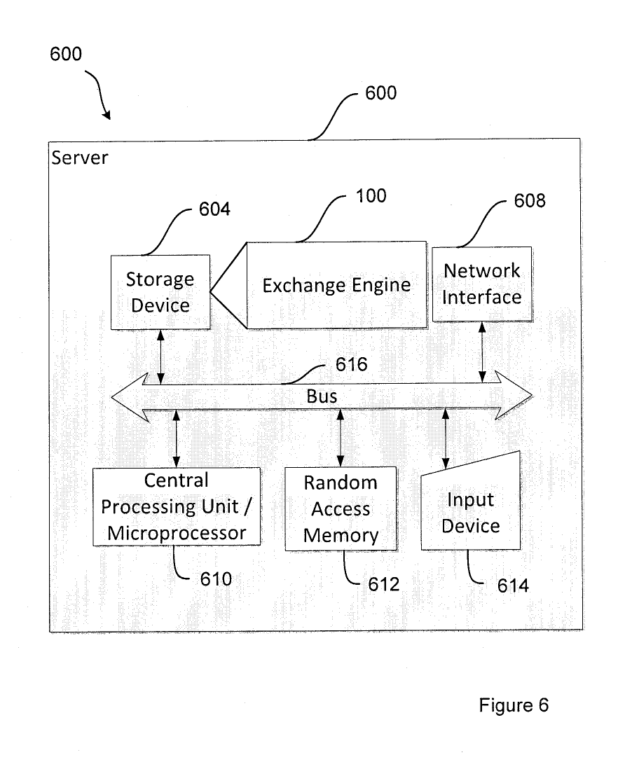

FIG. 1 is a block diagram of an exemplary exchange engine 100. Exemplary embodiments of the engine 100 can be implemented using hardware, software, and/or a combination thereof For example, in one exemplary embodiment, one or more computing devices, such as one or more servers, can be configured to implement exemplary embodiments of the engine 100. An exemplary embodiment of a computing device programmed and/or configured to implement exemplary embodiments of the engine 100 is shown, for example, in FIGS. 2 and 6. The engine 100 can include an acceptance engine 110, a random time period generator 115, a randomization engine 125, and a matching engine 130. The engine 100 can be programmed and/or include executable code to implement one or more order handling processes for one or more auctions of financial instruments.

Exemplary embodiments of the present disclosure can be used to implement periodic auctions in which electronic trading instructions are submitted over a period of time, referred to herein as the acceptance phase, after which the electronic trading instructions are executed. In exemplary embodiments, the periodic auctions can be implemented as continuous double auctions in which orders to buy and orders to sell a financial instrument are simultaneously submitted to the exchange engine 100 (e.g., operating as an auctioneer) and the matching engine 130 programmatically processes the electronic trading instructions according to a sequence determined by the randomization engine 125 to apply the electronic trading instructions to a limit order book of the matching engine 130. The matching engine 130 can generate matches continuously as the limit order book is updated with incoming electronic trading instructions from the randomly generated sequence of electronic trading instructions.

The auctions implemented by the engine 100 can occur in sequence and/or in parallel with each other. In some embodiments, the auctions can be completed on the order of seconds, minutes, hours, and so on. In one exemplary embodiment, the engine 100 can implement a sequence of temporally consecutive auctions during a trading period (e.g., a trading day) and each auction can be completed in a few seconds.

Exemplary embodiments of the engine 100 can be implemented as a stand-alone exchange and/or can be incorporated/implemented as part of another exchange, such as the NASDAQ, NYSE, Chicago Board of Options Exchange, Chicago Board of Trade, Chicago Mercantile Exchange, London Stock Exchange, Deutsche Borse, Tokyo Stock Exchange, Mercantile Exchange, New York Mercantile Exchange, Eurex, LIFFE and/or any other exchanges.

The acceptance engine 110 can be programmed and/or configured to receive, accept, and maintain electronic trading instructions from participants of an electronic auction (i.e. auction participants). The acceptance engine 110 can be programmed and/or configured to accept different types of electronic trading instructions, such as placement orders (e.g., buy orders, sell orders, a put orders, a call orders), cancel requests (e.g., requests to cancel previously submitted placement orders), and/or any other suitable electronic trading instructions. In one exemplary embodiment, the electronic trading placement orders accepted by the engine 110 can be orders for selling/buying financial instruments, such as stocks, bonds, commodities, futures, ETFs, mutual funds, options, currencies, swaps, and/or any other suitable items that may be traded in an exchange market. In some embodiments, the acceptance engine 110 can be programmed to notify auction participants that an acceptance phase is open (or will be beginning) and that the participants can begin placing electronic trading instructions when the acceptance phase is open. The acceptance engine 110 can be programmed and/or configured to terminate the acceptance phase after an acceptance time period expires, which can be a randomly generate time period.

The electronic trading instructions received from the auction participants, via the auction participants' electronic devices, can include parameters that can be used by the engine 100 when determining how to process the electronic trading instructions. Some examples of parameters that can be included in the electronic trading instructions can include a limit price parameter, a duration parameter, a quantity (or size) parameter, an order type parameter, a participant identifier, and/or any other suitable parameters that can be used by the engine 100 when processing the electronic trading instructions. The price parameter identifies a price at which the auction participant will buy or sell the financial instrument (e.g., a dollar amount or market price). The duration parameter identifies a time period over which the electronic trading instruction will be valid (e.g., guaranteed until cancelled, one day, one week, one auction cycle etc.). The quantity parameter identifies a quantity of the financial instruments the auction participant wishes to buy or sell (e.g., 100 shares of a stock). The instruction type parameter identifies the type of trading instruction being submitted by the auction participant (e.g., a market order, a limit order, a buy order, a sell order, a cancel request, and/or any other instruction types). The participant identifier provides an identity of the auction participant that is submitting the electronic trading instruction. In exemplary embodiments, the participant identifier can be, for example, a username, an account number, an IP address, a MAC address, a business name, a string of alphanumeric character, and/or any other suitable identifiers that can be used to distinguish between different auction participants.

In some embodiments, the acceptance engine 110 can be programmed and/or configured to limit a quantity of electronic trading instructions an auction participant can submit for each auction. For example, the acceptance engine 110 can monitor and track the electronic trading instructions being submitted by the auction participants and can reject an electronic trading instruction when the quantity of electronic trading instructions submitted by an auction participant exceeds a maximum quantity for that auction participant. In exemplary embodiments, each auction participant's electronic trading instructions can be monitored and tracked based on an auction participant identifier associated with the electronic trading instructions.

The random time period generator 115 can be programmed to specify a random time period that is applied to determine the duration of the acceptance phase of an auction. In some embodiments, the random time period generator 115 can implement a pseudo-random time period generator, which can be executed for each auction implemented during a trading period, such that the random time period can be determined each time an auction is run. The random time period determined by the generator 115 can be unknown to the auction participants so that the auction participants have no knowledge of the length of the acceptance phase. In some embodiments, a distribution and/or range of possible random time periods can be provided to the auction participants. The random time period can be determined by the random time period generator 115 prior to or after opening the acceptance order phase.

After the acceptance phase terminates in response to the expiration of the random time period, the randomization engine 125 can be programmed and/or configured to sort the electronic trading instructions. In one embodiment, the electronic trading instructions can be grouped based on the auction participant that submitted the electronic trading instructions. For example, electronic trading instructions associated with an identical auction participant identifier can be grouped programmatically. In an exemplary embodiment, the electronic trading instructions for each participant are grouped and the auction participant's electronic trading instructions can be delivered to the matching engine 130 as a unit. The randomization engine 125 can be programmed and/or configured to randomly sort the groups of electronic trading instructions to define an order queue. The random sorting applied by the engine 125 randomly determines a position of an auction participant's group of electronic trading instructions in the order queue for the auction, and the order instructions within each group can be maintained in the sequence in which they were received by the acceptance engine 110.

The matching engine 130 can be programmed and/or configured to receive the groups of electronic trading instructions in a sequence defined by the order queue as determined based on the random sorting by the randomization engine 125. In some exemplary embodiments, a group of electronic trading orders can be submitted as a unit to the matching engine 130. In some exemplary embodiments, the matching engine 130 can implement a continuous double auction for the auction in which the matching engine continuously attempts to match placement orders (e.g., match order to buy with orders to sell as the orders are received based on whether the bid price of a buy order exceeds an ask price of the sell order). The matching engine 130 programmatically attempts to match the received electronic trading instructions for the groups of electronic trading instructions (grouped by auction participant) with other electronic trading instructions in the order queue based on the order sequence. The matching engine 130 programmatically matches orders with other orders by applying one or more matching priority rules to the electronic trading instructions. For example, the matching engine 130 can programmatically match placement orders based on a price-time matching algorithm, a price-size priority matching algorithm, a price-participant-time matching algorithm, and/or any other suitable matching algorithm.

The matching engine 130 can be programmed and/or configured to process cancel requests included in the groups of electronic trading instructions in the order queue as the cancel requests are received by the matching engine 130 (e.g., when a group including a cancel request is received by the matching engine, the cancel request in the group is processed). In some embodiments, the matching engine 130 can apply each electronic trading instruction from a group associated with a single given participant to the limit order book in the order received, so if the participant submits a placement order and cancel request for that placement order in the same auction, the placement order can first be applied to the order book (potentially matching against resting orders), and then cancelled if the placement order is not matched (e.g., prior to processing the next randomly-sorted participant's instructions). In some embodiments, the matching engine 130 can pre-process the electronic trading instructions from a group associated with the participant so that if a cancel request was sent for a placement order in the same auction, the placement order is cancelled before being applied to the limit order book at all such that the placement order will not be matched against any resting orders.

The price-time matching gives matching priority to placement orders based on a price specified in the placement orders and the time and sequence at which the placement orders are delivered to the matching engine 130 (not the time at which the orders are received by the acceptance engine 110). For example, the order queue, which includes the randomly sorted groups of electronic trading instructions (i.e., grouped by auction participant), can be submitted to the matching engine 130 and the matching engine 130 can apply the electronic trading instructions from the order queue to its limit order book in the sequence determined by the randomization engine 125. In one embodiment, as electronic trading instructions are processed by the matching engine 130, the matching engine 130 can identify whether the electronic trading instructions are placement orders or cancel requests. If the matching engine 130 determines that the trading instruction corresponds to a placement order, the matching engine 130 attempts to execute the placement order by attempting to match a resting order or orders in the limit order book (e.g., buy orders specifying a price that greater than the lowest sell order price already present in the limit order book) with the placement order. If the matching engine 130 determines that the trading instruction corresponds to a cancel request, the matching engine 130 attempts to cancel the corresponding placement order in the limit order book. Alternatively, the matching engine can pre-process electronic trading instructions in each group to cancel a placement order before it can be applied to the limit order book if the group includes a cancel request associated with the placement order.

The price-size priority matching algorithm is similar to price-time matching except that matching priority is given to resting orders in the limit order book based on their order size (e.g., a value of the quantity parameter in the electronic trading instructions) rather than their (randomly chosen) arrival time. For example, when the matching engine 130 considers matching an incoming sell order against a number of buy orders in the limit order book at a given limit price, the matching engine 130 can give priority to orders in the limit order book having a smaller size. Alternatively, matching priority can be given to electronic trading instructions in the limit order book having a larger size. Alternatively, matching may be performed pro-rata where a fraction of the sell order is matched against each of the eligible buy orders in the limit order book at the given limit price in proportion to the size of each buy order.

The price-participant-time matching is similar to price-time matching, but incorporates participant information when processing the electronic trading instructions. For example, when the matching engine 130 considers an incoming sell order against a number of resting buy orders in the limit order book at a given limit price, the matching engine 130 may give priority to resting buy orders with the same participant identifiers as the incoming sell order. The participant identifiers used by the matching engine 130 to determine a priority can be the same and/or different participant identifiers used by the randomization engine 125.

FIG. 2 depicts an exemplary electronic trading exchange environment 200. The environment 200 includes an electronic trading exchange platform 210 that includes one or more computing devices configured as servers 212, as well as one or more databases 214, and auction participants' systems 220 that can include, for example, one or more auction participant electronic devices, which can be computing devices programmed and/or configured to interface with the trading exchange platform 210. The auction participants' systems 220 can be communicatively coupled to the trading exchange platform 210 via a communications network 250. The communication network 250 can be the Internet, an intranet, a virtual private network (VPN), a wide area network (WAN), a local area network (LAN), and the like. The environment 200 can be configured to implement one or more electronic auctions to allow auction participants, via the electronic devices 222, to sell and/or buy financial instruments, such as stocks, bonds, commodities, futures, ETFs, mutual funds, options, currencies, swaps, and/or any other suitable items that may be traded in an exchange market.

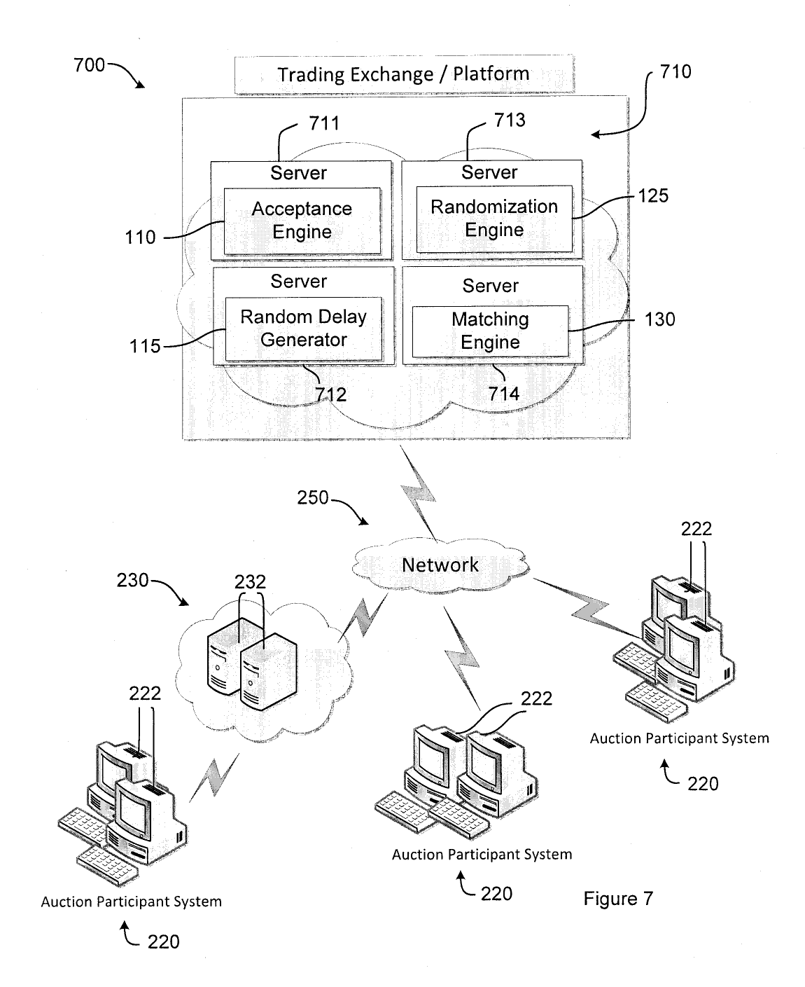

At least one of the servers 212 associated with the electronic trading exchange platform 200 can be programed to execute an embodiment of the exchange engine 100. An exemplary embodiment of a computing device configured as a server for executing the exchange engine 100 is shown in FIG. 6. In some embodiments, portions of the exchange engine 100 can be distributed across the servers 212, as shown in FIG. 7. Referring to FIG. 2, the one or more databases 214 can store the electronic trading instructions received by the electronic trading exchange platform 210, auction information, and/or any other information that can be used to implement exemplary embodiments of the present disclosure. The auction information can include, for example, auction results, auction start times, auction participants, random time periods for determining a termination of the acceptance phase of previous, pending and/or subsequent auctions, and/or any other auction information that can be used to implement the auctions in accordance with exemplary embodiments or to maintain a record of auctions previously implemented by the trading exchange platform 200.

In exemplary embodiments, the auction participants' systems 220 can be associated with one or more hedge funds, brokerages, financial institutions, investment banks, institutional investors, trustees, fund managers, individual investors, and/or any other entities that may wish to participate in one or more auctions implemented by trading exchange platform 210. The one or more computing devices configured as electronic devices 222 can be implemented as, for example, a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein. In exemplary embodiments, some of the electronic devices 222 can include a client-side application that is programmed and/or configured to facilitate interaction between the electronic devices 222 and the trading exchange platform 210. In some embodiments, the client-side application can be a web-browser configured to navigate to a web page hosted by the trading exchange platform, which allows the auction participants to submit their electronic trading instructions. In some embodiments, the client-side application can be a software application specific to the trading exchange platform 210.

In some embodiments, one of the auction participant systems 220 can include electronic devices that are programmed and/or configured to interact with an intermediary system 230, which can include one or more servers 232 programmed and/or configured to communicate with the trading exchange platform 210 on-behalf of the auction participants' systems 220. For example, an auction participant can submit an electronic trading instruction to the intermediary system 230 via one of the electronic devices 222 and the intermediary system 230 can process and forward the electronic trading instruction to the trading exchange platform 210. In some embodiments, the intermediary system 230 can be, for example, a broker-dealer.

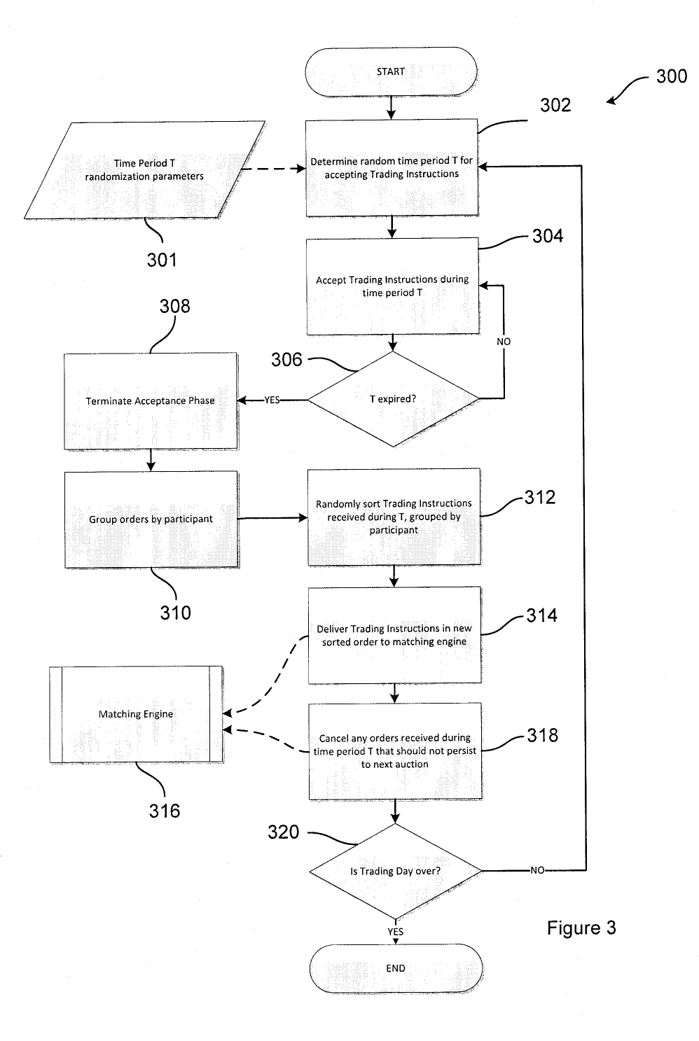

FIG. 3 is a flowchart of an exemplary order handling process 300 that can be implemented by an exemplary embodiment of the engine 100 being executed, for example, as part of an embodiment of the electronic trading environment 200. At step 302, the engine 100 can programmatically determine a random time period T that can be used to determine the duration of the acceptance phase, and in step 304 the engine 100 can be programmed to open an acceptance phase to begin accepting electronic trading instructions for the auction from the auction participants. The random time period T can be determined using the generator 115 based on one or more randomization parameters 301 (e.g., a minimum possible time period or a maximum possible time period) and the random time period T used by exemplary embodiments to determine a point in time at which the acceptance phase is scheduled to terminate.

If the random time period T has not expired at step 306, the engine 100 continues accepting electronic trading instructions at step 304. Otherwise, the engine 100 terminates the acceptance phase in response to the expiration of the random time period T at step 308 and at step 310 the electronic trading instructions can be grouped by auction participant. At step 312 the engine 100 randomly sorts the groups of electronic trading instructions to define an order queue having a randomly generated sequence of grouped electronic trading instructions. A relative position of the groups of electronic trading instructions in the order queue can determine when the groups of electronic trading instructions are processed by matching engine 130. For example, groups of electronic trading instructions positioned toward the beginning of the order queue can be processed by the matching engine 130 before groups of electronic trading instructions positioned towards the end of the order queue.

At step 314, the engine 100 can deliver the electronic trading instructions to the matching engine 130 of the engine 100 according to the sequence defined by the order queue based on the random sort and at step 316 the matching engine 100 can execute the order matching. The engine 100 can match placement orders based on, for example, a price-time matching algorithm, a price-size priority matching algorithm, a price-participant-time matching algorithm, and/or any other suitable matching algorithm. At step 318, the engine 100 can cancel any placement orders received during the acceptance phase that were not matched with other placement orders and have not been set to persist to the next auction. At step 320, the engine 100 determines if another auction is scheduled to occur. If another auction is scheduled, the process repeats from step 302 at which time a different random period can be applied to the acceptance phase of the new auction. Otherwise, the process ends.

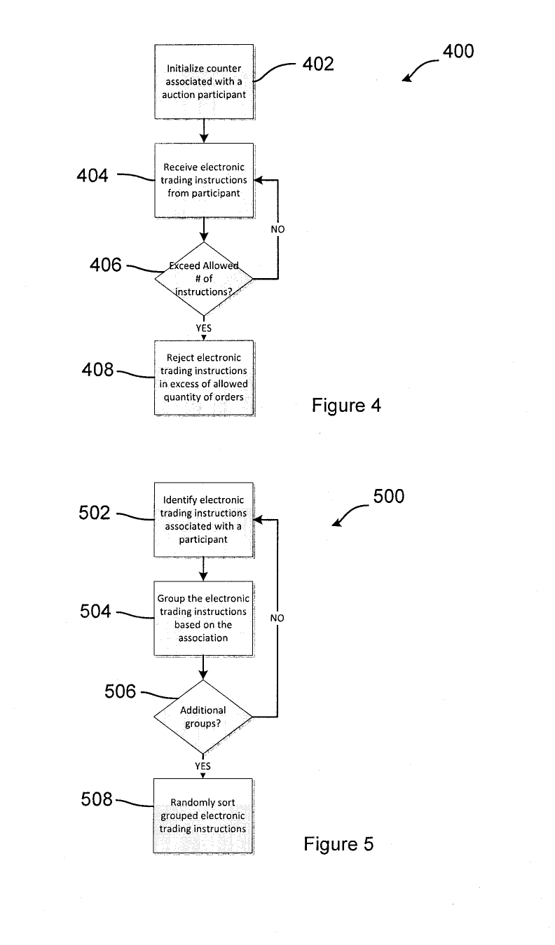

FIG. 4 is a flowchart showing an overview of one exemplary process 400 for the step of accepting electronic trading instructions in FIG. 3 (i.e., step 304). At step 402, the engine 100 can initialize a counter for an auction participant and can receive an electronic trading instruction from the auction participant at step 404. A participant identifier can be associated with the electronic trading instruction to associate the electronic trading instruction with the auction participant submitting the electronic trading instructions. As one example, in one embodiment, the participant identifier can be included in or associated with the electronic trading instruction. The participant identifier can include a username, a business name, a string of alphanumeric character, and/or any other suitable identifiers that can be used to distinguish between different auction participants. As another example, in one embodiment, the engine 100 can be programmed to assign the electronic trading instruction the participant identifier based on an origin or source of the electronic trading instruction (e.g., an IP address, MAC address, an account number, and/or any other suitable origin information). Upon accepting the electronic trading instruction for the auction participant, the engine 100 can programmatically increment a value of a counter implemented by the engine 100 for each electronic trading instruction received at step 404 to track a quantity of electronic trading instructions that have been submitted by the auction participant.

At step 406, the value of the counter is compared to a specified value, which can represent a maximum allowed quantity of electronic trading instructions that can be submitted by the auction participant. If the value of the counter is not equal to or greater than the specified value, the auction participant can submit another electronic trading instruction, which can be processed by the engine at step 402. If, however, the value of the counter is equal to or greater than the specified value, the engine rejects the electronic trading instruction at step 408 and does not allow the auction participant to submit another further electronic trading instruction during the pending auction.

FIG. 5 is a flowchart showing an overview of one exemplary process 500 for the step of randomly sorting electronic trading instructions in FIG. 3 (i.e., step 310). At step 502, the engine 100 identifies electronics trading instructions that are associated with a participant identifier. At step 504, the electronic trading instructions associated with the participant identifier are grouped to form a participant group corresponding to the participant identifier. At step 506, the engine 100 determines whether additional participant groups can be formed. For example, the engine 100 can programmatically identify whether there are any remaining electronic trading instructions that have not been grouped and can identify the participant identifier(s) associated with the remaining electronic trading instructions. If an additional group can be formed, the engine 100 continues the process at step 502 to form another group of electronic trading instructions for another auction participant. If no further groups can be formed, the engine 100 proceeds to step 508 at which the engine 100 randomly sorts the groups of electronic trading instructions to generate an order queue having a randomly sorted sequence of groups.

FIG. 6 is a diagram showing hardware and software components of an exemplary system 600 capable of performing the processes discussed above. The system 600 includes a processing server 602 (e.g., a computer), which can include a storage device 604, a network interface 608, a communications bus 616, a central processing unit (CPU) 610 (e.g., a microprocessor), a random access memory (RAM) 612, and one or more input devices 614 (e.g., a keyboard or a mouse). The processing server 602 can also include a display (e.g., a liquid crystal display (LCD) or a cathode ray tube (CRT)) The storage device 604 can include any suitable, computer-readable storage medium (e.g., a disk, non-volatile memory, read-only memory (ROM), erasable programmable ROM (EPROM), electrically-erasable programmable ROM (EEPROM) or flash memory). The processing server 602 can be, for example, a networked computer system, a personal computer, a smart phone, a tablet, and the like.

The engine 100, or portions thereof, can be embodied as computer-readable program code stored on one or more non-transitory computer-readable storage device 604 and can be executed by the CPU 610 using any suitable, high- or low-level computing language or platform, such as Java, C, C++, C#, .NET, and the like. Execution of the computer-readable code by the CPU 610 can cause the engine 100 to implement embodiments of one or more processes. The network interface 608 can include, for example, an Ethernet network interface device, a wireless network interface device, any other suitable device which permits the processing server 602 to communicate via the network, and the like. The CPU 610 can include any suitable single- or multiple-core microprocessor of any suitable architecture that is capable of implementing and/or running the engine 100 (e.g., an Intel processor). The random access memory 612 can include any suitable, high-speed, random access memory typical of most modern computers, such as dynamic RAM (DRAM).

FIG. 7 is a block diagram of a distributed electronic trading exchange environment 700 in accordance with exemplary embodiments of the present disclosure. As shown in FIG. 7, an exemplary embodiment of the exchange engine 100 can be distributed across servers 711-714 associated with a trading exchange platform 710. For example, the server 711 can include acceptance engine 110, the server 712 can include the random time period generator 115, the server 713 can include the randomization engine 125, and the server 714 can include the matching engine 130. The servers 711-714 can be communicatively coupled to facilitate interaction between the servers 711-714 to implement one or more order handling processes of the engine 100. The electronic devices 222 associated with the auction participants' systems 220 can be communicatively coupled to the trading exchange platform 710 via the network 250 to facilitate an interaction between the auction participant systems 220 and the trading exchange platform 710 as described herein. In some embodiments, the auction participant systems 220 can interface with the trading exchange platform through the intermediary system 230.

In describing exemplary embodiments, specific terminology is used for the sake of clarity. For purposes of description, each specific term is intended to at least include all technical and functional equivalents that operate in a similar manner to accomplish a similar purpose. Additionally, in some instances, where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A method of processing electronic trading instructions in an electronic trading exchange environment comprising:
accepting electronic trading instructions from auction participants' electronic devices in a first phase of an electronic auction;
programmatically terminating the first phase after expiration of a random time period;
executing code to randomly sort the electronic trading instructions to generate an order queue; and
programmatically matching the electronic trading instructions based on a randomized sequence of electronic orders defined by the order queue.

2. The method of claim 1, wherein executing code to randomly sort the electronic trading instructions comprises:
grouping the electronic trading instructions accepted during the first phase to generate groups of electronic trading instructions based on participant identifiers associated with the electronic trading instructions; and
executing code to randomly sort the groups of electronic trading instructions to generate a random ordering of the groups of electronic trading instructions.

3. The method of claim 1, wherein the random time period is not disclosed to auction participants.

4. The method of claim 1, further comprising restricting an accepted quantity of the electronic trading instructions from each auction participant to a specified quantity of electronic trading instructions.

5. The method of claim 1, further comprising:
monitoring a quantity of electronic trading instructions submitted by an auction participant based on participant identifiers associated with the electronic trading instructions;
comparing the quantity of electronic trading instructions submitted by the auction participant to a specified value; and
rejecting electronic trading instructions from the auction participant in response to the quantity exceeding the specified value.

6. The method of claim 1, further comprising executing a subsequent auction after the auction ends, wherein the subsequent auction applies a different random time period, the expiration of which determines when the first phase of the subsequent auction is terminated.

7. The method of claim 6, wherein at least one of the electronic trading instructions that is not matched in the auction is entered into the subsequent auction automatically.

8. The method of claim 1, wherein at least one of the electronic trading instructions that is not matched in the auction is automatically canceled.

9. A non-transitory computer-readable medium storing instruction executable by a processing device in an electronic trading exchange environment, wherein execution of the instructions by the processing device causes processing of electronic trading instructions in the electronic trading exchange environment, the processing comprising:
accepting electronic trading instructions from auction participants' electronic devices in a first phase of an electronic auction;
programmatically terminating the first phase after expiration of a random time period;
executing code to randomly sort the electronic trading instructions to generate an order queue; and
programmatically matching the electronic trading instructions based on a randomized sequence of electronic orders defined by the order queue.

10. The medium of claim 9, wherein execution of code to randomly sort the electronic trading instructions comprises:
execution of code to group the electronic trading instructions accepted during the first phase to generate groups of electronic trading instructions based on participant identifiers associated with the electronic trading instructions; and
execution of code to randomly sort the groups electronic trading instructions to generate a random ordering of the groups electronic trading instructions.

11. The medium of claim 9, wherein the random time period is not disclosed to auction participants.

12. The medium of claim 9, wherein execution of the instructions causes the processing device to restrict an accepted quantity of the electronic trading instructions from each auction participant to a specified quantity of electronic trading instructions.

13. The medium of claim 9, wherein execution of the instructions causes the processing device to:
monitor a quantity of electronic trading instructions submitted by an auction participant based on participant identifiers associated with the electronic trading instructions;
compare the quantity of electronic trading instructions submitted by the auction participant to a specified value; and
reject electronic trading instructions from the auction participant in response to the quantity exceeding the specified value.

14. The medium of claim 9, wherein execution of the instructions causes the processing device to execute a subsequent auction after the auction ends, the subsequent auction applying a different random time period, the expiration of which determines when the first phase of the subsequent auction is terminated.

15. The medium of claim 14, wherein at least one of the electronic trading instructions that is not matched in the auction is entered into the subsequent auction automatically.

16. The medium of claim 9, wherein at least one of the electronic trading instructions that is not matched in the auction is automatically canceled.

17. A system of processing electronic trading instructions in an electronic trading exchange environment comprising:
at least one storage device storing instructions for an order handling process;
a processing device communicatively coupled to the at least one storage device, the processing device being programmed to execute the instructions to:
accept electronic trading instructions from auction participant electronic devices in a first phase of an electronic auction;
terminate the first phase after expiration of a random time period;
randomly sort the electronic trading instructions to generate an order queue; and
match the electronic trading instructions based on a randomized sequence of electronic orders defined by the order queue.

18. The system of claim 17, wherein the processing device is programmed to execute the instructions to randomly sort the electronic trading instructions by:
grouping the electronic trading instructions accepted during the first phase to generate groups of electronic trading instructions based on participant identifiers associated with the electronic trading instructions; and
executing code to randomly sort the groups electronic trading instructions to generate a random ordering of the groups electronic trading instructions.

19. The system of claim 17, wherein the random time period is not disclosed to auction participants.

20. The system of claim 17, wherein the processing device is programmed to execute the instructions to restrict an accepted quantity of the electronic trading instructions from each auction participant to a specified quantity of electronic trading instructions.

21. The system of claim 17, wherein the processing device is programmed to execute the instructions to:
monitor a quantity of electronic trading instructions submitted by an auction participant based on participant identifiers associated with the electronic trading instructions;
compare the quantity of electronic trading instructions submitted by the auction participant to a specified value; and
reject electronic trading instructions from the auction participant in response to the quantity exceeding the specified value.

22. The system of claim 17, wherein the processing device is programmed to execute the instructions to execute a subsequent auction after the auction ends, the subsequent auction applying a different random time period, the expiration of which determines when the first phase of the subsequent auction is terminated.

23. The system of claim 22, wherein at least one of the electronic trading instructions that is not matched in the auction is entered into the subsequent auction automatically.

24. The system of claim 17, wherein at least one of the electronic trading instructions that is not matched in the auction is automatically canceled.
